(19) United States
(12) Patent Application Publication
(10) Pub. No.: US 2020/0210483 A1
(43) Pub. Date: Jul. 2, 2020

(54) ENHANCE A MAIL APPLICATION TO GENERATE A WEEKLY STATUS REPORT

(71) Applicant: Citrix Systems, Inc., Fort Lauderdale, FL (US)

(72) Inventor: Ashish Gujarathi, Parkland, FL (US)

(21) Appl. No.: 16/232,444

(22) Filed: Dec. 26, 2018

(51) Int. Cl. G06F 16/9035; G06F 7/08; G06F 16/248

(52) U.S. Cl. CPC G06F 16/9035; G06F 16/248; G06F 7/08

(57) ABSTRACT

System and methods discussed for automatically generating periodic event data reports based on calendar and task data from an email application or productivity suite. These systems and methods reduce user interaction and effort for generating intuitive, simple to understand reports, and provide additional classification and prioritization of events for easier consumption. The compiled reports may also be smaller than the individual event data items, due to removal of redundant header metadata, potentially reducing storage requirements and bandwidth to transfer the information to other devices.

### FIELD OF THE DISCLOSURE

The present application generally relates to processing of event data.

### BACKGROUND OF THE DISCLOSURE

Many productivity applications, such as email clients or other office suite applications, provide calendar appointment functionality and task management. Users may generate appointment or task requests to add them to a calendar and/or task list to generate reminders, as well as sending requests to other users for their own calendar or task lists. However, management of these calendar and task events may be unwieldy for users, as email clients and office suite applications typically lack report generation capabilities. In particular, it may be hard for users to easily determine what task and meeting activities have been completed in the prior week or days, or determine what activities are upcoming in the near future, without multiple interactions with the software, applying various search and filter rules, and manually aggregating task and meeting information from disparate views or programs. As many enterprises require employees to generate weekly status reports, these tedious manual tasks must be repeated often, frequently taking upwards of half an hour or more to generate a useful report.

### BRIEF SUMMARY OF THE DISCLOSURE

The system and methods discussed herein provide for automatically generating periodic event data reports based on calendar and task data from an email application or productivity suite. These systems and methods reduce user interaction and effort for generating intuitive, simple to understand reports, and provide additional classification and prioritization of events for easier consumption. The compiled reports may also be smaller than the individual event data items, due to removal of redundant header metadata, potentially reducing storage requirements and bandwidth to transfer the information to other devices.

In one aspect, the present disclosure is directed to a method for status report generation. The method includes retrieving, by a device, a plurality of event data records having dates within a first range. The method also includes filtering, by the device, recurring events from the plurality of event data records. The method also includes sorting, by the device, the filtered event data records in order of priority. The method also includes generating, by the device, a status report comprising the sorted filtered event data records.

In some implementations, the method includes, for a first subset of filtered event data records, identifying a priority of each event data record based on one or more individuals associated with the event data record; and sorting the first subset of event data records according to the identified priority. In a further implementation, each event data record of the first subset comprises a meeting data record; and the method includes identifying the priority of each event data record of the first subset by identifying the priority of the event data record based on a number of individuals associated with the meeting data record. In a still further implementation, the method includes identifying the priority of each event data record of the first subset by identifying the priority of the event data record based on a classification of each individual associated with the meeting data record.

In some implementations, the method includes, for a second subset of filtered event data records: identifying a status of each event data record, and sorting the second subset of event data records according to the identified status. In a further implementation, each event data record of the second subset comprises a task data record; and the method includes identifying a status of each event data record of the second subset by identifying a completion status associated with the task data record.

In some implementations, the method includes transmitting, by the device, the status report to a second device. In some implementations, the method includes receiving a request for a status report, by the device, the request specifying the first range.

In another aspect, the present disclosure is directed to a device for status report generation. The device includes a processor executing a report generator, and a network interface in communication with a data server. The report generator is configured to retrieve a plurality of event data records having dates within a first range; filter recurring events from the plurality of event data records; sort the filtered event data records in order of priority; and generate a status report comprising the sorted filtered event data records.

In some implementations, the report generator is further configured to, for a first subset of filtered event data records: identify a priority of each event data record based on one or more individuals associated with the event data record, and sort the first subset of event data records according to the identified priority. In a further implementation, each event data record of the first subset comprises a meeting data record; and the report generator is further configured to identify the priority of the event data record based on a number of individuals associated with the meeting data record. In a still further implementation, the report generator is further configured to identify the priority of the event data record based on a classification of each individual associated with the meeting data record.

In some implementations, the report generator is further configured to, for a second subset of filtered event data records: identify a status of each event data record, and sort the second subset of event data records according to the identified status. In a further implementation, each event data record of the second subset comprises a task data record; and the report generator is further configured to identify a completion status associated with the task data record.

In some implementations, the report generator is further configured to transmit, via the network interface, the status report to a second device. In some implementations, the report generator is further configured to receive a request for a status report, the request specifying the first range.

In still another aspect, the present disclosure is directed to a tangible computer-readable medium comprising instructions, that when executed by a processor, cause the processor to: retrieve a plurality of event data records having dates within a first range; filter recurring events from the plurality of event data records; sort the filtered event data records in order of priority; and generate a status report comprising the sorted filtered event data records.

In some implementations, the medium further comprises instructions that, when executed by the processor, cause the processor to, for a first subset of filtered event data records: identify a priority of each event data record based on one or more individuals associated with the event data record, and sort the first subset of event data records according to the identified priority. In a further implementation, each event data record of the first subset comprises a meeting data record; and the instructions further cause the processor to identify the priority of the event data record based on a number of individuals associated with the meeting data record.

In some implementations, the medium further comprises instructions that, when executed by the processor, cause the processor to, for a second subset of filtered event data records: identify a status of each event data record, and sort the second subset of event data records according to the identified status.

The details of various embodiments are set forth in the accompanying drawings and the description below.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1 is a block diagram illustrating an implementation of a computing device for use with the systems and methods discussed herein;

FIG. 2A is a table depicting header information for a plurality of calendar event data items, according to some implementations;

FIG. 2B is a table depicting header information for a plurality of task event data items, according to some implementations;

FIG. 2C is an illustration of an example event status report, according to some implementations;

FIG. 3 is a block diagram of an implementation of a system for event status report generation; and

FIG. 4 is a flow chart of an implementation of a method for event status report generation.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for status report generation.

### A. Computing Environment

Prior to discussing the specifics of embodiments of the systems and methods for status report generation, it may be helpful to discuss the computing environments in which such embodiments may be deployed.

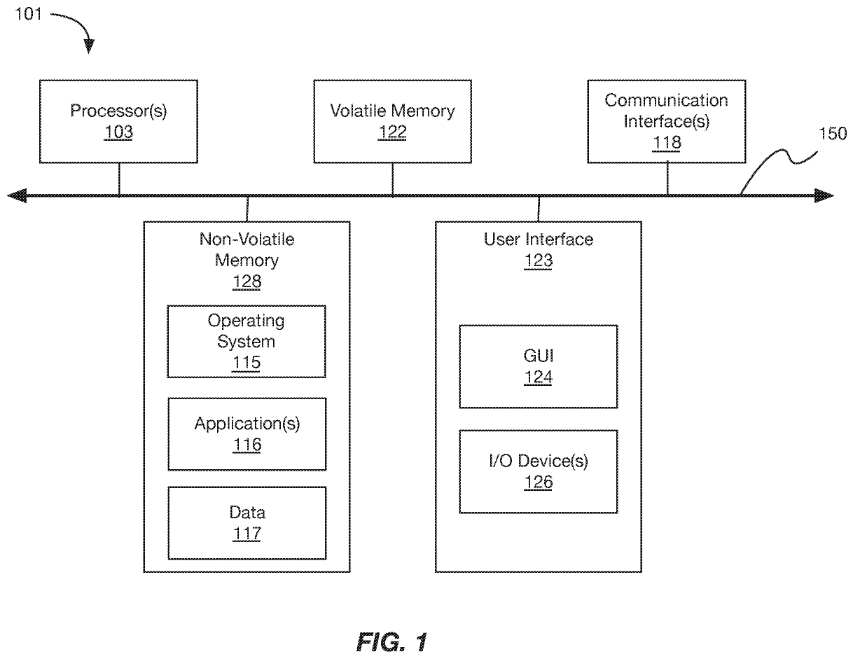

As shown in FIG. 1, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O devices(s) 126. Various elements of computer 101 may communicate via one or more communication buses, shown in communication bus 150.

Computer 101 as shown in FIG. 1 is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” a be embodied in one or more application specific integrated circuits (ASICs), microprocessors, digital signal processors (DSPs) graphics processing units (GPUs), microcontrollers, field programmable gate arrays (FPGAs), programmable logic arrays (PLAs), multi-core processors, or general-purpose computers with associated memory. The “processor” may be analog, digital, or mixed-signal. In some embodiments, the “processor” may be one or more physical processors or one or more “virtual” (e.g., remotely located or “cloud”) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop including one or more of: one or more applications, one or more desktop applications, and one or more desktop sessions in which one or more applications may execute.

Additional details of the implementation and operation of network environment, computer 101 and client and server computers may be as described in U.S. Pat. No. 9,538,345, issued Jan. 3, 2017 to Citrix Systems, Inc. of Fort Lauderdale, Fla., the teachings of which are hereby incorporated herein by reference.

### B. Systems and Methods for Status Report Generation

Many productivity applications, such as email clients or other office suite applications, provide calendar appointment functionality and task management. Users may generate appointment or task requests to add them to a calendar and/or task list to generate reminders, as well as sending requests to other users for their own calendar or task lists.

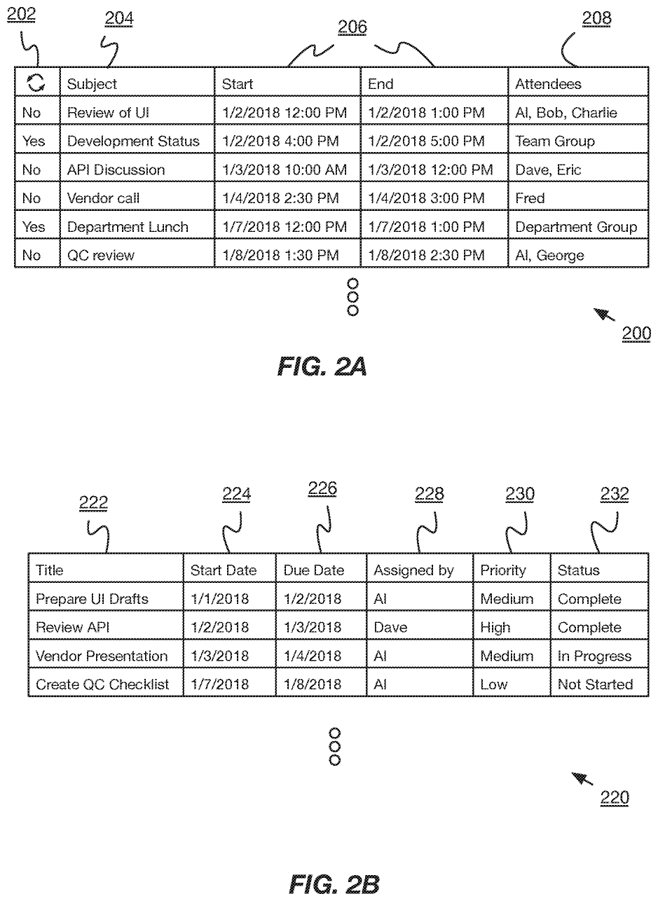

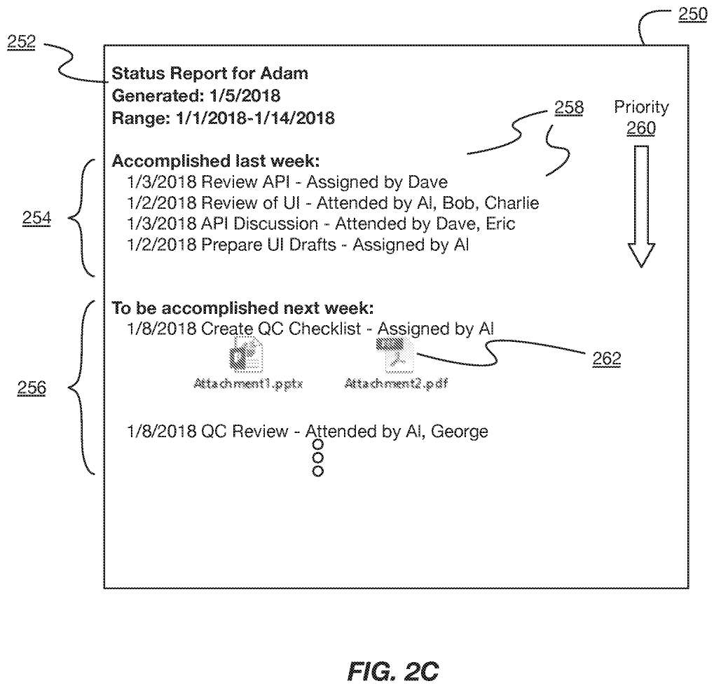

For example, FIG. 2A is a table 200 depicting example headers of calendar items in a calendar application, email program, or office productivity suite, according to one implementation. The headers may comprise metadata of calendar items, which may be in any format or protocol (e.g. XML data, ICS data, etc.), and may include subject or title information 204, start and/or end times and dates 206, as well as attendees and/or originators 208. In some implementations, attendees or originators may be identified by email address, user name, employee identifier, or any other type and form of identification. In many implementations, a calendar, email, or office productivity program may allow calendar items to be set to be automatically recurring, which may be identified by a flag 202 or other identifier. Such items may automatically periodically recur (e.g. once a week at a specified time). In many implementations, calendar event entries may include additional information not illustrated, such as meeting locations or rooms, additional text descriptions, file attachments or links to files, etc.

Similarly, FIG. 2B is a table 220 depicting example headers of task items in a calendar application, email program, or office productivity suite, according to one implementation. As with calendar entries, the task headers may comprise metadata of task items, which may be in any format or protocol (e.g. XML data, ICS data, etc.), and may include subject or title information 222, start dates and/or due dates 224, 226, assignors 228, priority levels 230, and progress status identifiers 232. In many implementations, task event entries may include additional information not illustrated, such as additional text descriptions, file attachments or links to files, etc.

Management of these calendar and task events, referred to collectively as event data records or event data entry or by similar terms, may be unwieldy for users. For example, many email clients and office suite applications typically lack report generation capabilities, and users may be limited to printing tables of entries as illustrated in FIGS. 2A and 2B. These tables may be difficult to read at a glance and lack visual separation between items or activities that have been completed, and those that may be upcoming in the near future. Even in implementations in which reports may be generated, they may require multiple interactions with the software, applying various search and filter rules, and manually aggregating task and meeting information from disparate views or programs, increasing user frustration. As many enterprises require employees to generate weekly status reports, these tedious manual tasks must be repeated often, frequently taking upwards of half an hour or more to generate a useful report. As a result, many users may disregard these tasks, making planning of enterprise resources difficult.

The system and methods discussed herein provide for automatically generating periodic event data reports based on calendar and task data from an email application or productivity suite. These systems and methods reduce user interaction and effort for generating intuitive, simple to understand reports, and provide additional classification and prioritization of events for easier consumption. The compiled reports may also be smaller than the individual event data items, due to removal of redundant header metadata, potentially reducing storage requirements and bandwidth to transfer the information to other devices.

FIG. 2C is an illustration of an example status report 250 for the example event data records depicted in FIGS. 2A-2B, according to some implementations. The status report 250 may be generated in any appropriate format or protocol, such as XML or HTML data, text or rich text format (RTF) data, or any other format.

In many implementations, the status report 250 may comprise a header 252 identifying a user or account, a report creation date, and/or an event data record range. Ranges may be selected by a user or administrator of the system, and may comprise a range of time with the present date at the center (e.g. a two week period, consisting of a prior week and a future week around a current date, or any other such range). The body of the status report 250 may be divided into a first portion 254 of items or activities accomplished during a prior time period, as well as a second portion 256 of items or activities accomplished during an upcoming time period. Each of first portion 254 and second portion 256 may identify, in abbreviated form, calendar and task data records 258 corresponding to activities that were, respectively, completed or occurred during the prior time period, or are planned to occur during the upcoming time period. In many implementations, these records may be ordered chronologically within each portion; while in other implementations, the records may be ordered by priority 260 as shown. Priority of calendar and task entries may be explicitly identified or set (e.g. as shown in FIG. 2B) or may be dynamically determined. For example, in some implementations, the system may calculate a priority score for an item responsive to the number of individuals associated with the item. For instance, a calendar entry with a large number of individuals may receive a high priority score compared to a calendar entry with a low number of individuals. Scoring may be linear or proportionally weighted according to a function (e.g. in one implementation, the difference in priority scores between meetings with two or three attendees may be similar to the difference in priority scores between meetings with twenty or thirty attendees). In some implementations, scoring may alternatively or in addition be based on classifications of individuals associated with the item. For instance, a calendar entry with an important attendee, such as a manager or executive, may be scored higher than a calendar entry with an equal or lower-level colleague. These scoring systems may be combined, with classification scores for each individual attending added together (e.g. score=K₁+K₂+K₃+ . . . , with K₁=3 for an executive, K₂=2 for a colleague, and K₁ for a junior or assistant colleague).

In some implementations, attachments 262 from event data records may be included as links in the status report and may be placed in-line as shown with the corresponding event data record, allowing easy access to relevant information. In some implementations, the attachments may be provided with the report (e.g. for transmission to a second device), while in other implementations, the links may comprise a uniform resource locator (URL) or address at which the attachment may be retrieved (e.g. from a file server, network storage location, cloud storage location, or other such storage). Similarly, in some implementations, each entry within the status report may link to the corresponding event data record, allowing the user to access the record directly within their email program or office productivity suite.

As discussed above, in many implementations, event data record information may be abbreviated within the status report for clarity and ease of consumption. For example, in the implementation illustrated in FIG. 2C, each event data record has been reduced to a completion or occurrence date, a subject, and an attendee or assignor list. In other implementations, more or less information may be included.

In some implementations, recurring event records may be excluded from the status report, as these recurring meetings may just be status checks and not indicative of accomplished actions. For example, recurring calendar appointments illustrated in the example of FIG. 2A have been excluded from the report of FIG. 2B. Similarly, in many implementations, calendar event data records with a single pair of attendees (e.g. the user and one other attendee) may be excluded from the status report, as these may also represent short discussions during an activity without it being completed. In other implementations, either or both of these types of event records may be included in the status report.

In many implementations, the status report may be generated as a draft report and provided to the requesting user (either on the same device, or transmitted by the system to a client device of the user). The user may refine the report and edit or add additional information, and then provide the finalized report to one or more additional users. In other implementations, the status report may be generated and provided to the user and/or one or more additional users directly.

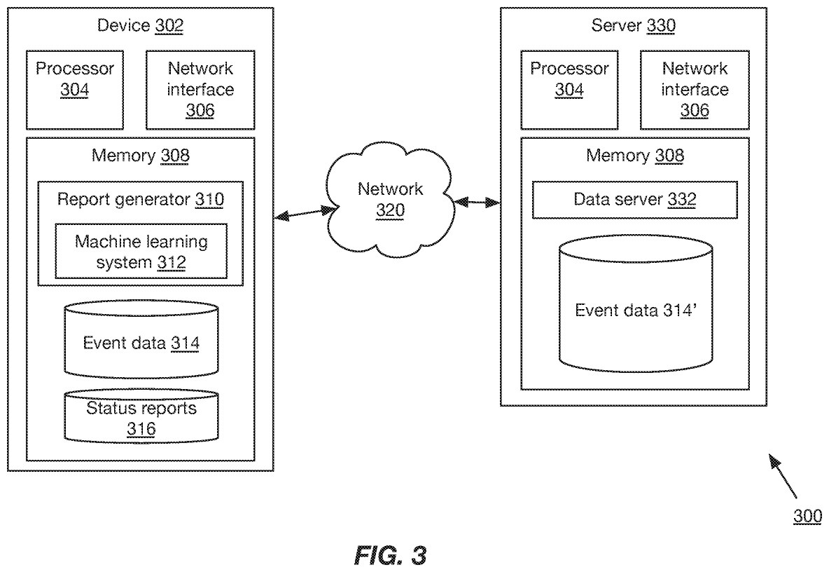

FIG. 3 is a block diagram of an implementation of a system for event status report generation. A device 302, sometimes referred to as a user device, client device, or by other such terms, may communicate with a server 330, sometimes referred to as an application server, mail server, Exchange server, or by other such terms, via a network 320. Although only one device 302 is illustrated, in many implementations, multiple devices 302 may communicate with each other and/or with a server 330 via one or more networks 320.

Device 302 may comprise a laptop computer, desktop computer, tablet computer, wearable computer, smart phone, console, smart television, embedded computer, workstation, or any other type and form of computing device. In some implementations, device 302 may comprise a virtual machine executed by one or more hardware machines and communicating with another computing device for display to a user (e.g. via a remote desktop protocol). Device 302 may be any type of device 101 discussed above, and may comprise one or processors 304 (which may be similar to processors 103 discussed above); network interfaces 306 (which may be similar to communications interfaces 118 discussed above); and memory devices 308 (which may be similar to memory 122, 128 discussed above).

Memory 308 may include a report generator 310, which may comprise an application, service, server, daemon, routine, or other executable logic for parsing and analyzing calendar and task event data records and generating event status reports. Report generator 310 may sometimes be referred to as a parser, analyzer, or extractor. Although shown on device 302, in some implementations, report generator 310 may be executed by a second device 302 or by server 330 and accessed by device 302. For example, device 302 may transmit a request for a report to server 330, which may execute a report generator 310 to generate a report for a selected range of event data records, and then provide the report in response.

In some implementations, report generator 310 may retrieve and parse event data records via predetermined character-based or word-based matching via a match to a regular expression (regex) string to identify a priority score for the event data record, e.g. based off identification of words such as “final” or “update” or “initial” (reflecting high, medium, and low priority in some implementations), or any other such word-score combinations. In some implementations, report generator 310 may also generate a score based off associated individuals (e.g. originators of a task, or attendees to a meeting) as discussed above. Scores may be calculated as a combination of any of these or other factors (e.g. plus 0.5 due to a title including “final”, plus 1.5 due to inclusion of an executive, plus 0.5 due to inclusion of an assistant, etc.). The event data records may be ordered in the report based on this calculated score, to provide a dynamic ordering system responsive to metadata in each event data record.

In some implementations, report generator 310 may incorporate a machine learning system 312, such as a neural net or regression-based analyzer. Machine learning may be useful in some implementations for more accurately scoring priority of event data records. As discussed above, in some implementations, the status report may be provided as a draft to a user, and the user may edit or adjust the status report, including explicitly adjusting priorities of event data record entries or implicitly adjusting priorities by reordering entries in a preferred priority order. The updated status report may be used to retrain the machine learning system and adjust bias coefficients within the network, increasing accuracy of the system over time. Inputs to the machine learning network may comprise any or all metadata of the event data records, including originators, attendees, start times or dates, end times or dates, completion statuses, manually set priorities, subjects or titles, locations, body text, attachments, time of creation of the event data record, or any other type and form of information.

Report generator 310 may utilize event data records stored in a local database 314 or in a database 314′ maintained by a server 330. In some implementations, a local database 314 may comprise a subset of event data records maintained in database 314′ (e.g. retrieved upon demand or pushed by a server 332 to the device). Event data 314, 314′ may be stored in any appropriate data structure, such as a database, flat file, compressed archive, or any other such data. Event data may include attachments, in some implementations, while in other implementations, event data may include pointers or links to attachments stored separately.

Status reports may be stored in a database 316 maintained by report generator 310. Database 316 may be in any format, such as a flat file, relational database, or other data structure. In many implementations, status reports may be generated as XML data files, with tags identifying dates and times, subjects or titles, attendees, or any other information.

In some implementations, a server 330 may execute a data server 332. Data server 332 may comprise an application, service, daemon, routine, or other executable logic for sending, receiving, and storing calendar and/or task event data records, including attachments, as well as other related data (e.g. email, notes, or other such data). Data server 332 may store data locally (e.g. in event database 314′) or may store data in one or more data servers (not illustrated).

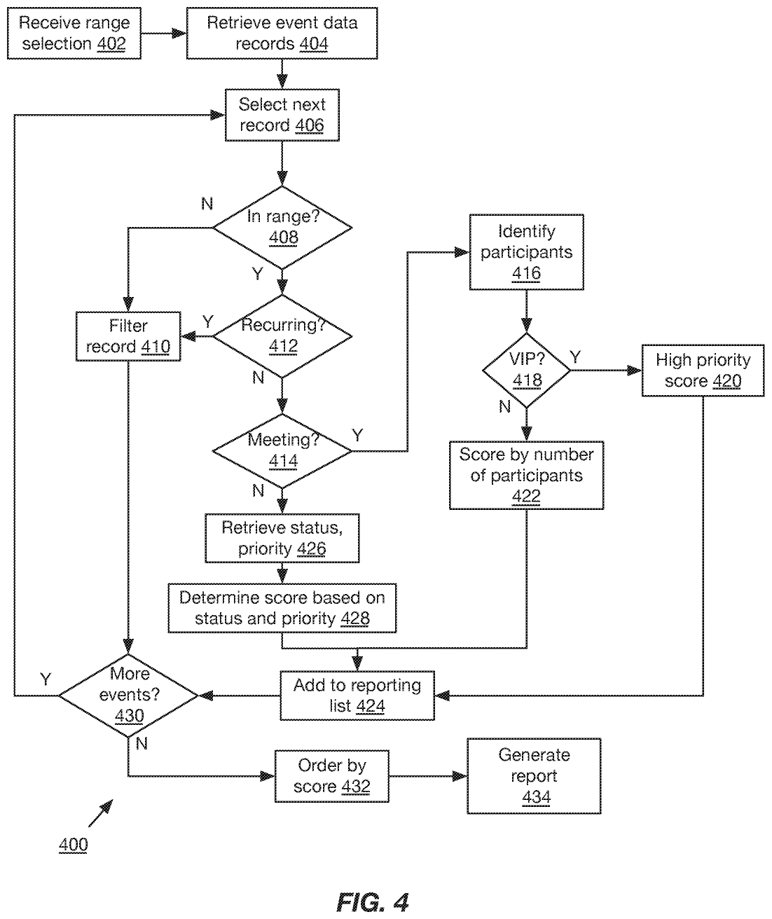

FIG. 4 is a flow chart of an implementation of a method 400 for event status report generation. At step 402, a device or report generator executed by a device may receive a request to generate a report. The request may comprise a date range selection in some implementations (e.g. two weeks, one month, etc.), while in other implementations, the range selection maybe predetermined or preset (e.g. by an administrator or developer). The selection may be received from a user of the device, e.g. via a graphical or text user interface of report generator 310; or may be received in a request from another device (e.g. in a request packet, with a date range identified in a payload or header of the request). Requests from another device may be via any suitable protocol, such as a RESTful request (e.g. HTTP POST or GET request comprising a parameter-value pair identifying a range).

At step 404, the report generator or device may retrieve event data records from a local database or remote database (e.g. at a data server). In some implementations, the event data records may be retrieved according to the specified date range (e.g. for a two week range centered on the present day, the device may retrieve event data records between the date d−7 and d+7, with d equal to the present date). In other implementations, the report generator or device may retrieve or access all event data records and filter the records according to the range at step 408, discussed below.

At step 406, the report generator or device may select a next record of the retrieved event data records. At step 408, in some implementations in which the report generator or device does not retrieve only a subset of records within a predetermined date range, the report generator or device may determine if the selected event record has a date within the specified date range. If not, at step 410, the event record may be filtered or excluded from inclusion in the event status report.

At step 412, in some implementations, the report generator or device may determine if the event record is a recurring event. In some implementations, the event record may include a flag or predetermined bit or other identifier set to indicate that the record is recurring on a periodic time frame. If so, in some implementations, at step 410 the event record may be filtered or excluded from inclusion in the event status report.

At step 414, in some implementations, the report generator or device may determine if the event record is a meeting or calendar event record. If so, then at step 416, in some implementations, the report generator or device may identify participants or attendees to the meeting or calendar event. In some implementations, the event record may include a list of invitees to whom the meeting request was sent and/or may include an identification of a sender. The invitees and sender may be identified by email address, account name, user name, real name, employee ID, or any other type and form of identifier. In some implementations, the event record may indicate whether each participant, invitee or sender has accepted or declined the meeting; in such implementations, the report generator or device may exclude from consideration participants or invitees that have declined the meeting.

Once participants or attendees are identified, in some implementations at step 418, the report generator or device may determine whether a participant is classified as an important individual in a user database. Important individuals may be identified by a user or administrator of the system, either explicitly or implicitly based on title, such as “executive”, “partner”, “team leader”, or other such identifiers. The report generator or device may retrieve user data of each participant or attendee and determine whether the individual is classified as an important individual, either based on a flag or other identifier, or based on a regex comparison of a predetermined string to a title of the individual in various implementations. If so, at step 420 in some implementations, the report generator or device may associate the event data record with a high priority score (e.g. a predetermined high value relative to a default score). If no participant or attendee is identified as an important individual, then at step 422, the report generator or device may calculate a priority score for the event data record based on the number of participants or attendees.

In some implementations, different priority score levels or coefficients may be applied based on title of the individual, such priority score levels set by an administrator or user of the system. For example, an individual associated with a title of “executive” may be given a first priority score, such as 2; an individual associated with a title of “team leader” may be given a second priority score, such as 1; and an individual associated with a title of “programmer” may be given a third priority score, such as 0.5. Any score values and titles or other status identifiers may be used in similar implementations. The report generator or device may calculate a priority score for the event as a function of the coefficients or priority scores of each individual attendee. The function may be addition of coefficients in some implementations, may be an average of priority scores in some implementations, or may be any other function. For example, in some implementations, the function may be a stepwise function, with a priority score for the event data record set to predetermined values according to the total individual priority scores falling within predetermined ranges (e.g. a sum of 0-3 results in a low priority score of 1, 4-8 results in a medium priority score of 2, 9 or higher results in a high priority score of 3, or any other such distribution).

In still other implementations, rather than steps 418-422, a machine learning system of the report generator or device may determine a priority score for the event data record, according to a reference data set of previously scored event data records. As discussed above, the machine learning system may be trained on user-corrections to priority scores or ordering in status reports, and may utilize any or all metadata of the event data record as inputs. Such systems may be inaccurate at first, and accordingly in some implementations, one or more of the above discussed implementations may be utilized initially until the machine learning system is sufficiently trained.

At step 424, the report generator or device may add the event data record to a report list, along with the calculated priority score. The report list may be maintained in temporary memory of the report generator or device in some implementations, as an intermediate aggregation step prior to generation of the report. In other implementations, the record may be added directly to the report, and the report subsequently sorted by priority. In some implementations, as shown in the example of FIG. 2C, events in the past (e.g. with an ending or due time or date prior to the present time and date) may be placed in a first list or portion of the status report, and events in the future (e.g. with a starting time or date after the present time and date) may be placed in a second list or portion of the status report.

If, at step 414, the event data record is a task data record rather than a meeting or calendar data record, then at step 426, in some implementations, the report generator or device may retrieve a status and/or priority of the task data record. The priority may be explicitly identified in metadata of the task data record (e.g. set by an originator of the task or another individual), in some implementations. At step 428, a priority score may be either calculated based on the explicitly identified priority or, in other implementations, calculated based on an identification of the originator as discussed above in connection with steps 418-422. For example, the report generator or device may retrieve a user record of the originating user of the task data record, perform a regex comparison on a title of the originating user identified in the user record, and assign a priority score to the task data record according to a policy corresponding to the title. In other implementations, a combination of both methods may be used, generating an aggregate score as a function of both an explicitly set priority and a priority assigned based on the originating user. In still other implementations, additional information may be used to determine the priority score, such as the task status (e.g. completed, in progress, not yet started, 50% complete, etc.). Predetermined score values may be assigned to the various potential task statuses, in some implementations, and may be used directly or aggregated with one or more additional scores (e.g. according to a priority field and/or originating individual's assigned priority score). In other implementations, a machine learning system may calculate a priority score for the task data record, similar to the implementation of machine learning discussed above in connection with calendar data records. The system may use any and all metadata of the task data record, and may be trained on user corrections to draft status report priority scores or priority ordering.

At step 424, the task data record may be added to the reporting list and/or event status report, as discussed above. At step 430, the report generator or device may determine if additional event data records are included in the retrieved set of records from step 404. If so, steps 406-430 may be repeated iteratively for each additional record.

At step 432, in some implementations, the report generator or device may sort one or both of the past and future portions of the reporting list or draft status report according to the assigned priority scores. In other implementations, the report generator or device may sort one or both of the past and future portions of the reporting list or draft status report in chronological order according to starting or ending times or dates for each event data record. In still other implementations, both sorting methods may be used, with entries first sorted by priority, with entries having equal priority scores sorted in chronological order.

At step 434, once complete, the status report may be finalized (e.g. adding a header or other summary or title indicators identifying previously completed events and future events, priority score levels or labels corresponding to predetermined score values, or other such information), and the report may be provided to the requestor (e.g. the user of the device, or a second device that provided a request for a conversation report to the device). The report may be transmitted to a second device, data server, or other entity for subsequent display, print-out, or other use.

Furthermore, as discussed above, in some implementations, the status report may be provided as a draft to the requesting user for modification or approval. The user may adjust priority scores for events explicitly or implicitly by reordering the event entries within the status report (e.g. via a graphical user interface provided by the device or a client device). In some implementations, the resulting user-assigned priorities or ordering may be provided to a machine learning system to correct priority score calculation bias weights.

Accordingly, the systems and methods discussed herein provide for automatically generating periodic event data reports based on calendar and task data from an email application or productivity suite. These systems and methods reduce user interaction and effort for generating intuitive, simple to understand reports, and provide additional classification and prioritization of events for easier consumption. The compiled reports may also be smaller than the individual event data items, due to removal of redundant header metadata, potentially reducing storage requirements and bandwidth to transfer the information to other devices. The systems and methods discussed herein may be particularly useful for legacy systems that do not easily generate prioritized status reports of calendar and task events for specified date ranges, providing functionality previously unavailable to these systems.

In should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and that these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code languages such as JAVA. The software programs or executable instructions may be stored on or in one or more articles of manufacture as object code.

While the foregoing writing description of the methods and systems enable one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufactured using programmable and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMS, ROMs, PROMs, RAMs, SRAMs, etc.), hardware (e.g., integrated circuit chip, Field Programmable Gate Array (FPGA), Application Specified Integrated Circuit (ASIC), etc.), electronic devices, a computer readable non-volatile storage unit (e.g., CD-ROM, hard disk drive, etc.). The article of manufacture may be accessible from a file server providing access to the computer-readable programs via a network transmission line, wireless transmission media, signals propagating through space, radio waves, infrared signals, etc. The articles of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described method and systems. Thus, the scope of the methods and systems described herein should not be limited by any of the illustrative embodiments and should be defined in accordance with the accompanying claims and their equivalents.

What is claimed is:

1. A method for status report generation, comprising:
retrieving, by a device, a plurality of event data records having dates within a first range;
filtering, by the device, recurring events from the plurality of event data records;
sorting, by the device, the filtered event data records in order of priority; and
generating, by the device, a status report comprising the sorted filtered event data records.

2. The method of claim 1, further comprising, for a first subset of filtered event data records:
identifying a priority of each event data record based on one or more individuals associated with the event data record, and
sorting the first subset of event data records according to the identified priority.

3. The method of claim 2, wherein each event data record of the first subset comprises a meeting data record; and wherein identifying the priority of each event data record of the first subset further comprises identifying the priority of the event data record based on a number of individuals associated with the meeting data record.

4. The method of claim 3, wherein identifying the priority of each event data record of the first subset further comprises identifying the priority of the event data record based on a classification of each individual associated with the meeting data record.

5. The method of claim 1, further comprising, for a second subset of filtered event data records:
identifying a status of each event data record, and
sorting the second subset of event data records according to the identified status.

6. The method of claim 5, wherein each event data record of the second subset comprises a task data record; and wherein identifying a status of each event data record of the second subset further comprises identifying a completion status associated with the task data record.

7. The method of claim 1, further comprising transmitting, by the device, the status report to a second device.

8. The method of claim 1, further comprising receiving a request for a status report, by the device, the request specifying the first range.

9. A device for status report generation, comprising:
a processor executing a report generator, and a network interface in communication with a data server;
wherein the report generator is configured to:
retrieve a plurality of event data records having dates within a first range,
filter recurring events from the plurality of event data records,
sort the filtered event data records in order of priority, and
generate a status report comprising the sorted filtered event data records.

10. The system of claim 9, wherein the report generator is further configured to, for a first subset of filtered event data records:
identify a priority of each event data record based on one or more individuals associated with the event data record, and
sort the first subset of event data records according to the identified priority.

11. The system of claim 10, wherein each event data record of the first subset comprises a meeting data record; and wherein the report generator is further configured to identify the priority of the event data record based on a number of individuals associated with the meeting data record.

12. The system of claim 11, wherein the report generator is further configured to identify the priority of the event data record based on a classification of each individual associated with the meeting data record.

13. The system of claim 9, wherein the report generator is further configured to, for a second subset of filtered event data records:
identify a status of each event data record, and
sort the second subset of event data records according to the identified status.

14. The system of claim 13, wherein each event data record of the second subset comprises a task data record; and wherein the report generator is further configured to identify a completion status associated with the task data record.

15. The system of claim 9, wherein the report generator is further configured to transmit, via the network interface, the status report to a second device.

16. The system of claim 9, wherein the report generator is further configured to receive a request for a status report, the request specifying the first range.

17. A tangible computer-readable medium comprising instructions, that when executed by a processor, cause the processor to:
retrieve a plurality of event data records having dates within a first range;
filter recurring events from the plurality of event data records;
sort the filtered event data records in order of priority; and
generate a status report comprising the sorted filtered event data records.

18. The computer-readable medium of claim 17, further comprising instructions that, when executed by the processor, cause the processor to, for a first subset of filtered event data records:
identify a priority of each event data record based on one or more individuals associated with the event data record, and
sort the first subset of event data records according to the identified priority.

19. The computer-readable medium of claim 18, wherein each event data record of the first subset comprises a meeting data record; and wherein the instructions further cause the processor to identify the priority of the event data record based on a number of individuals associated with the meeting data record.

20. The computer-readable medium of claim 17, further comprising instructions that, when executed by the processor, cause the processor to, for a second subset of filtered event data records:
identify a status of each event data record, and
sort the second subset of event data records according to the identified status.
